(19) United States
(12) Patent Application Publication
(10) Pub. No.: US 2015/0224016 A1
(43) Pub. Date: Aug. 13, 2015

(54) MASSAGE DEVICES

(71) Applicant: Pro Performance Sports, L.L.C., Carlsbad, CA (US)

(72) Inventor: Allen Keith Holland, Carlsbad, CA (US)

(21) Appl. No.: 14/460,101

(22) Filed: Aug. 14, 2014

Related U.S. Application Data
(60) Provisional application No. 61/939,553, filed on Feb. 13, 2014.

(51) Int. Cl. A61H 15/00

(52) U.S. Cl. CPC A61H 15/00; A61H 2015/0042

(57) ABSTRACT

A massager includes a holder having an opening and an insert insertable into and removable from the opening. The holder may be ball-shaped. Opposite ends of the insert may have different spherical curvatures, and the insert may have a cylindrical body. The holder may be softer than the insert. The insert may be inverted to provide an alternative surface for trigger point massaging or other applications. Alternatively, a massager may have a ball assembly in an opening of a holder, with the holder in the form of a truncated sphere. The cup may optionally have an outer surface having a curvature substantially matching the curvature of the holder. Balls or inserts may be provided on a strap loop, with the balls and inserts used in combination or individually.

### PRIORITY CLAIM

This Application claims priority to U.S. Provisional Patent Application No. 61/939,553, filed Feb. 13, 2014, and incorporated herein by reference.

### BACKGROUND OF THE INVENTION

Massage devices are used to massage different areas of the body. Massaging can loosen tight or knotted muscles, increase blood flow, and help in healing or conditioning. Massage devices often use rollers or balls of varying shapes. While these types of devices have met with varying degrees of acceptance and success, there is a need for improved massage devices and techniques.

### SUMMARY OF THE INVENTION

In a first aspect, a massager includes a holder having an opening and an insert insertable into and removable from the opening. The holder may be ball-shaped. Opposite ends of the insert may have different spherical curvatures, and the insert may have a cylindrical body. The holder may be softer than the insert.

In a second aspect a massager may have a ball assembly in an opening of a holder, with the ball assembly including a ball rotatably retained in a cup. The holder may be provided in the form of a truncated sphere. The cup may optionally have an outer surface having a curvature substantially matching the curvature of the holder.

In another aspect a massager may include a holder having a cup opening and an insert insertable into the cup opening. A strap or web extends through openings in the holder and in the insert, with both the holder and the insert slidable along lengths of web. Elements of one aspect or embodiment may be used in other embodiments.

### BRIEF DESCRIPTION OF THE DRAWINGS

In the drawings, the same element number indicates the same element in each of the views.

FIG. 1 is a top perspective view of a first massager design.

FIG. 2 is a bottom perspective view of the massager shown in FIG. 1.

FIG. 3 is a side perspective view of the massager shown in FIGS. 1 and 2.

FIG. 4 is a top perspective view of the holder of the massager shown in FIG. 1, with the insert removed for purpose of illustration.

FIG. 5 is an exploded perspective side view of the massager shown in FIG. 1.

FIG. 6 is a side elevation view of the massager of FIG. 1 with the insert inverted.

FIG. 7 is a section view of the massager as shown in FIG. 1.

FIG. 8 is a section view of the massager as shown in FIG. 6.

FIG. 9 is a side perspective view of a second massager design.

FIG. 10 is an exploded perspective side view of the massager shown in FIG. 9.

FIG. 11 is an exploded perspective bottom view of the massager shown in FIG. 9.

FIG. 12 is a top perspective view of the holder shown in FIG. 9 with the ball assembly removed for purpose of illustration.

FIG. 13 is a bottom and side perspective view of the ball assembly shown in FIGS. 10 and 11.

FIG. 14 is a perspective side view of a third massager design.

FIG. 15 is a perspective view of the inner ball on the web of the massager shown in FIG. 14, with the outer ball removed for purpose of illustration.

FIG. 16. is a perspective view of the outer ball shown in FIG. 15 separated from the web for purpose of illustration.

FIG. 17 is a front view of the inner ball shown in FIGS. 14 and 15.

FIG. 18 is a side view showing the massager of FIG. 14 in use for massaging the back.

FIG. 19 is a side view showing the massager of FIG. 14 in use for stretching.

FIG. 20 is a side view showing the massager of FIG. 14 in use for another type of stretching.

### DETAILED DESCRIPTION OF THE DRAWINGS

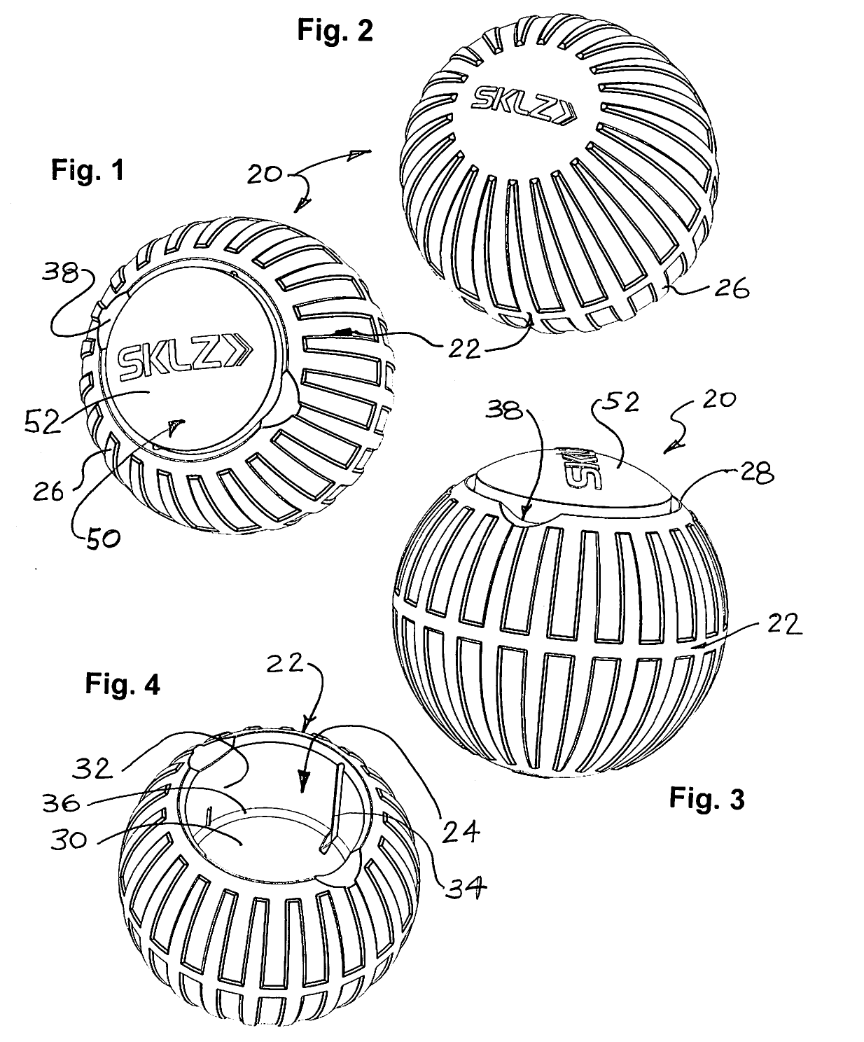

As shown in FIGS. 1-3, a massager 20 includes a holder 22 and an insert 50. The holder 22 may be provided in the form of a sphere truncated at a chord surface 28, with the sphere having a diameter similar to a tennis ball, of e.g., 6.3 to 6.9 cm (2.4-2.7 inches). Two or more cutouts 38 may be provided on the holder 22 to allow the insert 50 to be more easily grasped and removed by hand. As shown in FIG. 4, the holder 22 has a cup opening 24 for receiving the insert 50. The cup opening 24 may have cylindrical sidewalls 32 and a spherical bottom surface 30. An annular lip 36 may be provided in the cup opening 24 where the cylindrical sidewalls join the bottom surface 30. If used, the lip may be located at the equator of the holder 22. One or more ribs 34 may protrude inwardly from the cylindrical sidewalls 32 to better secure the insert 50 within the cup opening 24 and/or to reduce binding when insert 50 is inserted into the cup opening 24.

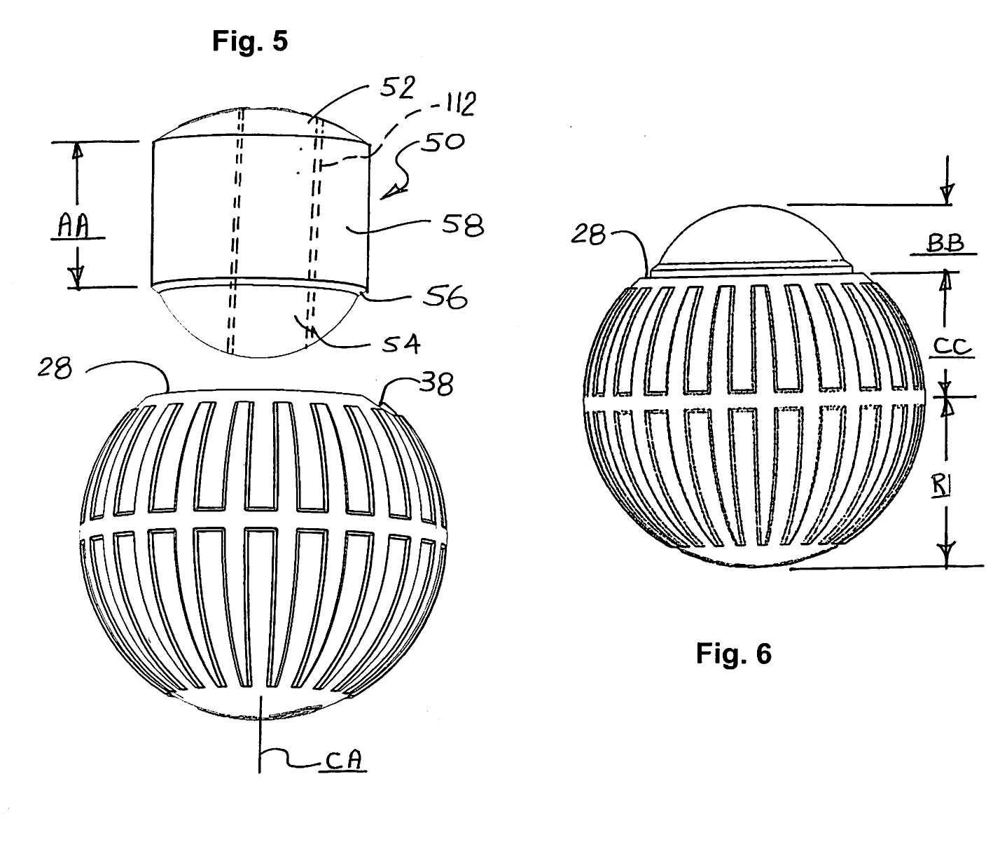

Referring to FIG. 5, the insert 50 may have a cylindrical body 58 having a curved first end 52 and a curved second end 54. Where the holder 22 is provided as a truncated ball or sphere, the first end 52 may have a spherical curvature matching the curvature of the holder 22. In this design, the length AA of the cylindrical body 58 may be selected so that with the insert 50 fully inserted into the holder 22, the second end 54 bottoms out in the cup opening 24, and the surface of the first end 52 is properly positioned relative to the outer surface of the holder 22 to form a substantially continuous sphere. The massager 20 formed of the holder 22 and the insert 50 then has an overall spherical shape, as shown in FIGS. 1, 3 and 7. As used here, substantially continuous sphere means that the first end 52 is spherically aligned with the holder to within 1, 2 or 3 mm.

The insert may alternatively have a non-cylindrical body, such as polygonal body. The first or second end of the insert may alternatively be flat, or have another non-spherical shape, depending on intended uses. For example, the surface of either end may be cylindrical rather than spherical. As described here, reference to diameter also includes the largest characteristic dimension of non-round or non-spherical shapes.

The holder 22 may be made of a relatively soft rubber or plastic material. The insert is generally made of a harder material, typically a harder rubber or plastic.

The ratio of the diameter of the insert 50 to the diameter of the holder 22 may range from about 0.5 to 0.75. With the insert 50 removed, the holder 22, or the top of the holder, is more flexible than with the insert installed.

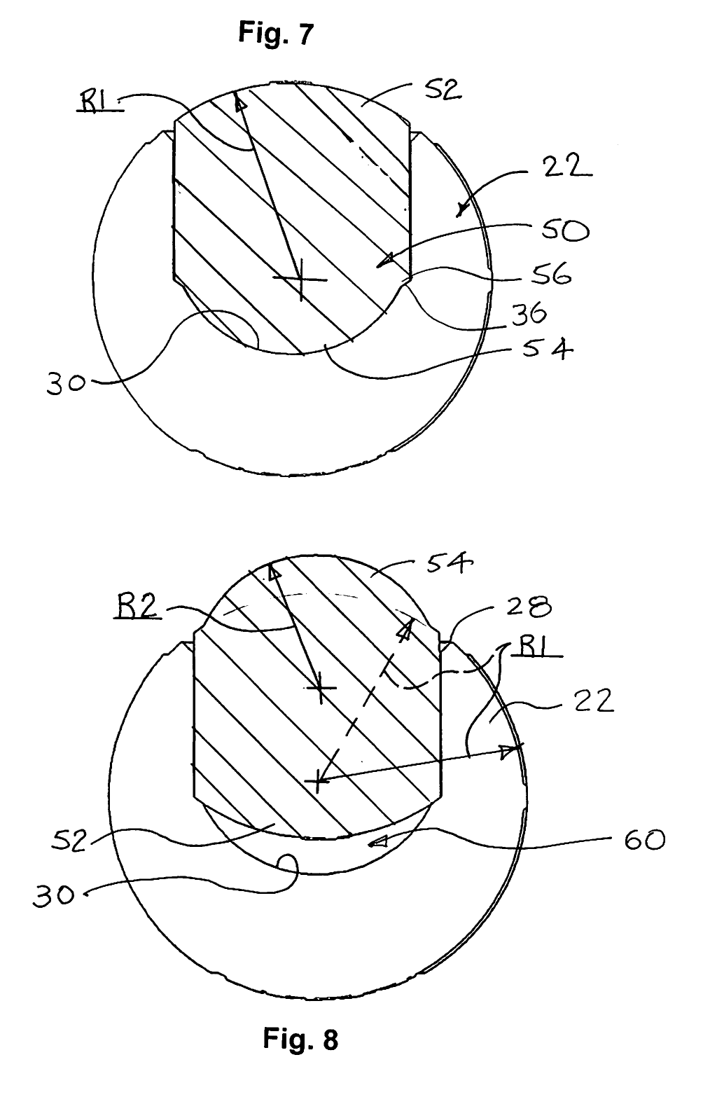

As shown in FIG. 5, the holder may be described as having a central axis CA that is parallel and concentric to the cup opening 24. The holder 22 may have gripping features to allow the user to more firmly grip the holder. The gripping features may be provided as evenly spaced apart meridian ridges 26 that are aligned with the central axis CA. Other gripping features such as grooves, depressions, raised dots, etc. may alternatively be used. If no gripping features are used, the holder 22 may have a truncated and smooth spherical outer surface. Dimension CC in FIG. 6 shows the latitude of the chord surface 28 which determines the extent of truncation, and R is the radius of the sphere. In general, the ratio of CC to R may range from 0.6 to 0.9 or from 0.75 to 0.85.

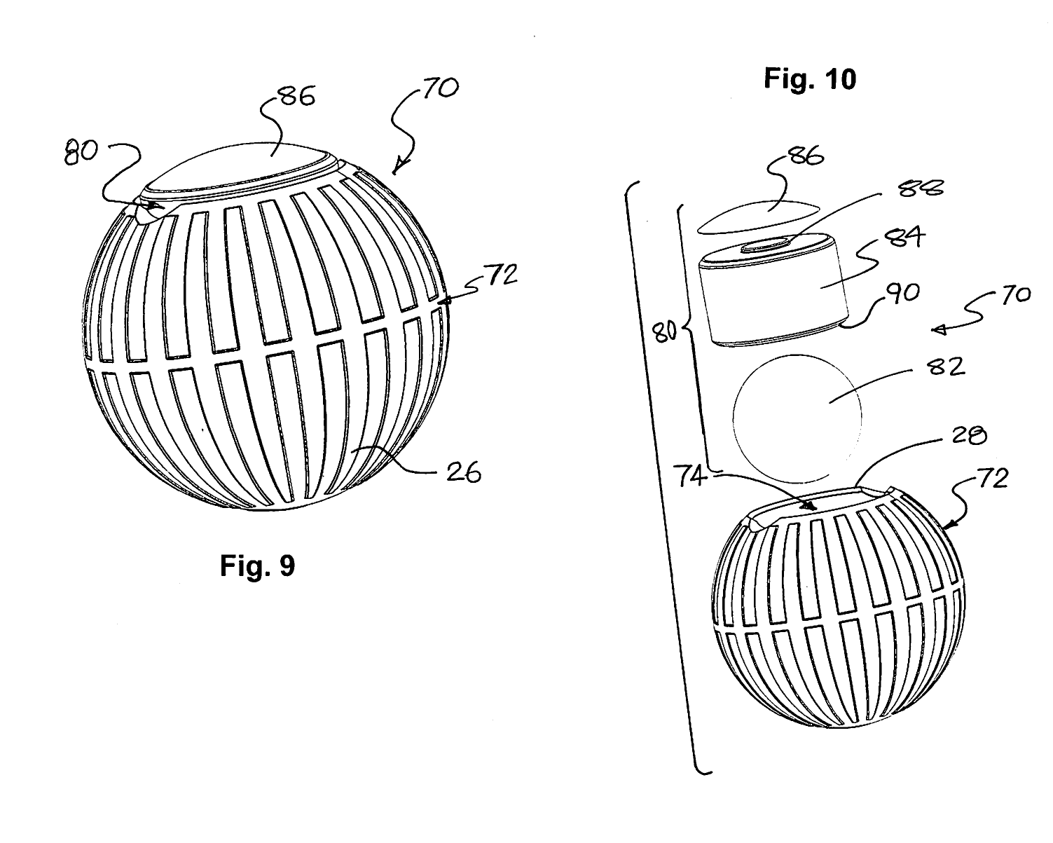

Turning to FIGS. 5-8, the second end 54 of the insert 22 may also have a spherical shape, typically with a smaller radius. For example, in FIG. 7 the first end 52 has the shape of a section of the surface of a sphere having a radius R1, so that the insert 22 and the holder 22 together form a complete sphere. In FIG. 7, with the insert fully inserted to form the complete sphere, the rim 56 on the insert may contact the lip 36 in the cup opening of the holder 22, and the second end 54 may also contact the bottom surface 30 of the cup opening 24. In the example of FIG. 7, these are complementary spherical surfaces.

FIG. 8 shows an insert 22 with the second end 54 having a the shape of a section of the surface of sphere having a radius R2, with R2 less than R1. As a result the second end 54 projects outwardly from the holder 22 by dimension BB in FIG. 6, which may range from 0.8 to 2.4 cm. Typically R2 may range from about 0.3-0.7 or 0.4 to 0.6 of R1. Also as shown in FIG. 8, wherein the bottom surface 30 of the cup opening 24 is shaped to conform to the second end 54, a gap 60 may be provided between the first end 52 of the insert 22 and the bottom surface 30, when the insert in installed into the holder with the second end 54 facing out.

In use, the massager 20 as configured in FIGS. 1-3 and 7 may be used as a massage ball. The insert 50 may be removed and the holder 22 may be used alone as a softer truncated massage ball. The insert 50 may also be used alone as a massage roller, for example for massaging the sole of the foot. The insert 50 may be removed, inverted and replaced, with the massager 20 then in the configuration shown in FIGS. 6 and 8. In this configuration the massager may be used for trigger point massaging, or for massaging smaller muscle groups.

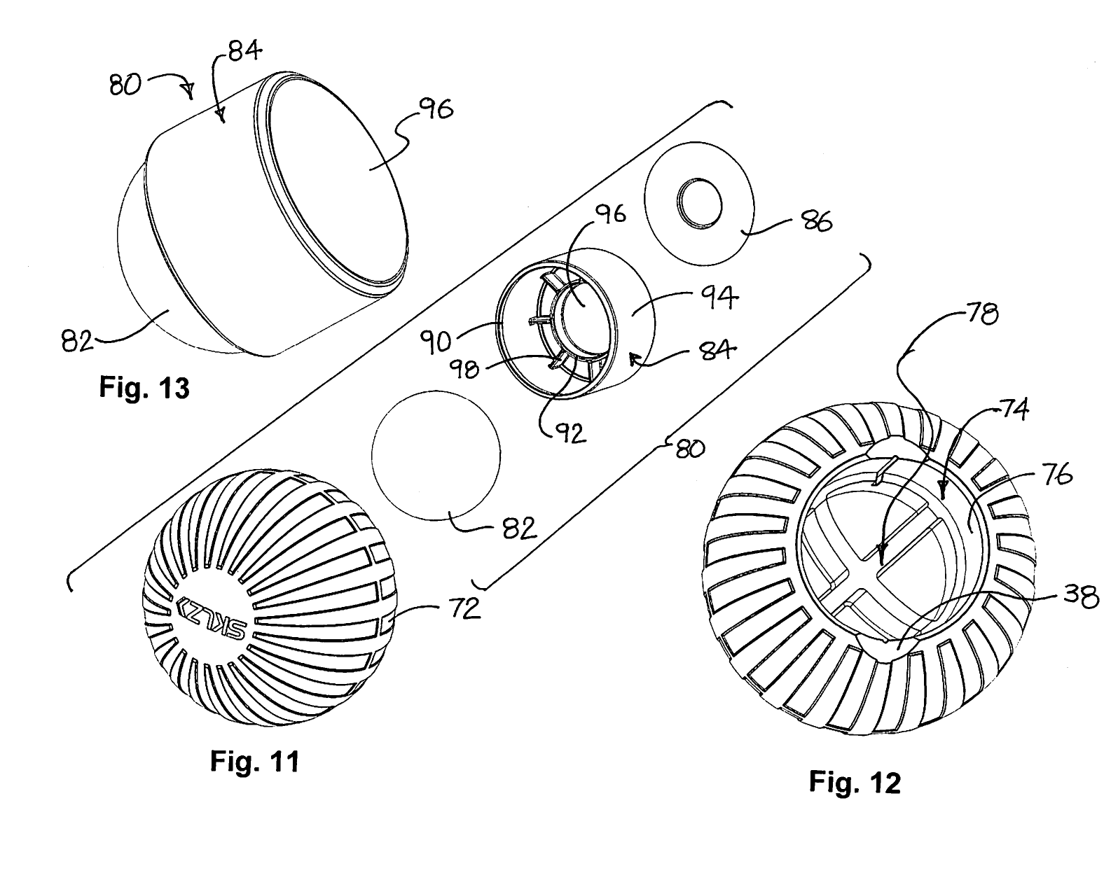

Turning to FIGS. 9 and 10, another massager design 70 has a ball assembly 80 insertable into and removable from a ball assembly opening 74 in a holder 72. The holder 72 may have a diameter of 7-12 or 9-10 cm. The holder 72 may otherwise be similar to the holder 22 described above. As shown in FIGS. 10, 11 and 13, the ball assembly 80 includes a ball 82 rotatably contained within a cup 84. The cup 84 may have a rim 90 nominally smaller than the diameter of the ball 82 so that the ball 82 may be pressed into the cup, and then retained in the cup 84. As shown in FIG. 11, the ball may supported on a ball seat 92 in the cup 84, with the ball seat 92 supported by gussets 98 extending inwardly from the tubular sidewalls 94 of the cup 84.

As shown in FIG. 13, the cup 84 may have a flat back or bottom surface or plate 96 to allow the ball assembly 80 to stay upright on a flat surface. Referring to FIG. 10, a cap 86 may optionally be attached to the outer side of the plate 96, for example via screw threads 88. Alternatively the cap 86 may be attached to the plate 96 via adhesives or other techniques. The cap 86, if used, may be provided with a spherical surface matching the curvature of the holder 72. The outer side of the plate may optionally be provided with a spherical surface and the cap omitted.

Turning to FIG. 12, the holder 72 may have a ball seat 78 at the bottom of the ball assembly opening 74, with the ball seat 78 having surfaces matching the curvature of the ball 82. The ball assembly 74 may be dimensioned so that with the ball 82 contacting the ball seat 78, the spherical surface of the cap 86, or of the outer side of the plate 96, forms a substantially complete sphere with the holder 72. The ball 82 may be made of a material harder than the holder 72. For example, the ball may be metal or harder plastic while the holder is a softer plastic or rubber.

The massager 70 as shown in FIG. 9 is configured as a complete sphere and may be used as a massage ball. As with the massager 20, the ball assembly 80 may be removed, by pulling it out by hand, to allow the holder 72 to be used separately as a softer truncated massage ball. The ball assembly 80 may be used separately from the holder 72, with the user holding the cup 84 and rolling the ball 82 on the body as desired. The cylindrical body of the cup 84 may be used as a massage roller.

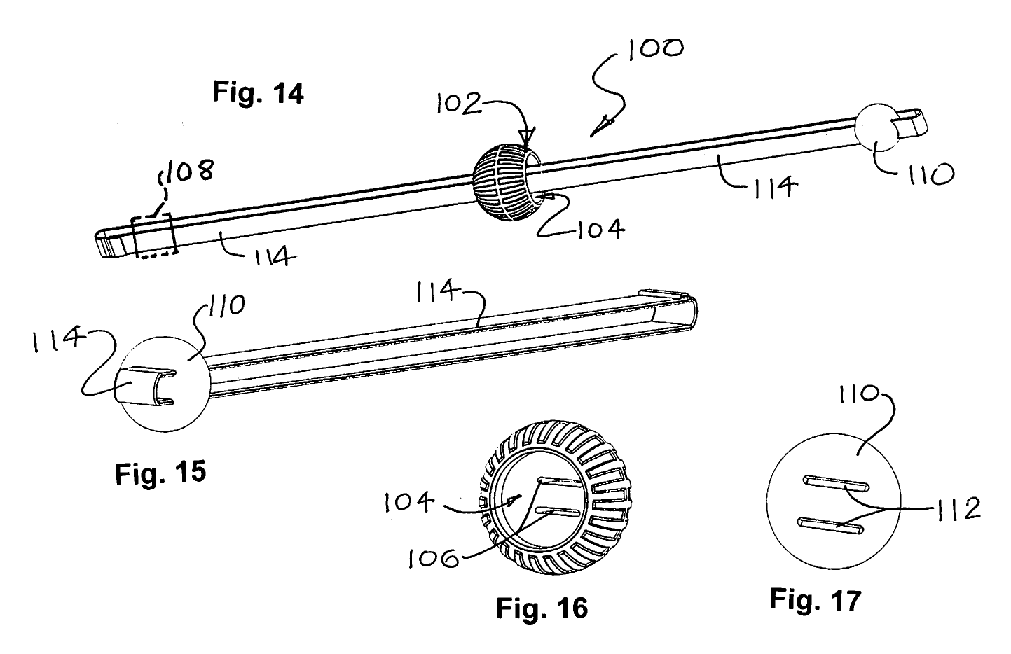

FIGS. 14 to 17 show another massager 100 which may include an outer ball 102 having recess 104. The outer ball 102 may be similar to the holder 22 described above. An inner ball 110 has a diameter nominally smaller than the recess, to allow the inner ball to be moved into and out of the recess 104. A loop of strap or webbing 114 extends through slots 112 in both the outer ball 102 and the inner ball 110. The webbing 114 may have a length (from end to end as shown in FIGS. 14) of 50 to 100 cm. The inner ball may be harder than the outer ball. The inner ball 110 may also be replaced by the insert shown in FIG. 5.

The outer and inner balls can slide along the webbing independently. With the inner ball 110 secured in the recess 104, the outer ball 102 provides a harder massage ball. The webbing allows the user the massage the back, for example by leaning against a wall with the outer ball 102 between the user and the wall. The inner ball 110 may be moved out of the recess 104 with the outer ball 102 then providing a softer massage ball. The inner ball 110 may be used apart from the outer ball, in a similar way, though typically for smaller muscle groups.

The slots 112 may be dimensioned to provide sufficient friction against the webbing 114 to prevent the balls from sliding freely. The balls then remain fixed in position on the webbing unless the user positively exerts force to cause them to slide on the webbing, for example a force of at least 0.5 or 1 Kgf. Of course, other techniques such as routing the webbing through or over bars, rings, or length adjusters, may also be used to prevent the balls from sliding freely on the webbing. An alternative design may use a single length of webbing passing through a single slot in the balls, rather than both sides of a loop passing through pairs of slots in the balls as shown in FIG. 14. In either design, the webbing may be replaced by rope or cord having a round cross section.

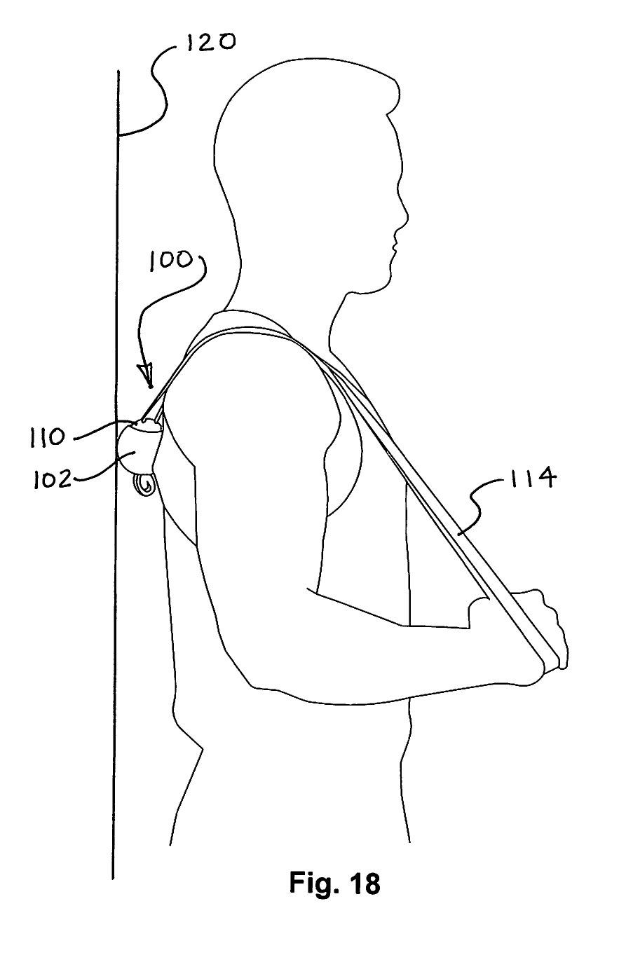

As shown in FIG. 18, the massager 100 may be used for massaging the back, with the user positioning either the outer ball 102 or the inner ball 110 between the back and wall 120. The vertical position of the ball may be adjusted via the position of the user's hand holding the strap 114. The ball may provide a horizontal massaging movement via the user shifting the back horizontally, by bending at the waist or via moving the feet. Vertical massaging movement may be achieved by movement of the strap or by bending the knees. Massaging pressure exerted by the ball may be adjusted via the user leaning into or away from the wall. As the user controls the massaging location, movement and pressure, there is instantaneous feedback. The user is also able to massage virtually all areas of the back without assistance.

In FIG. 18, either ball 102 or 110 may be positioned against the wall. If the outer ball 102 is positioned against the wall 120, the inner ball 110 may be positioned within the outer ball 102 to provide a harder massage surface, or the inner ball 110 may be removed from the outer ball and positioned in the user's hand at the opposite end of the strap 114, to provide a softer massage surface. Trigger point massage may be performed with the smaller and harder inner ball between the back and the wall. The strap 114 may optionally be positioned with one side of the strap on each shoulder, with the user's head between the strap sections, to more centrally position the ball on the back.

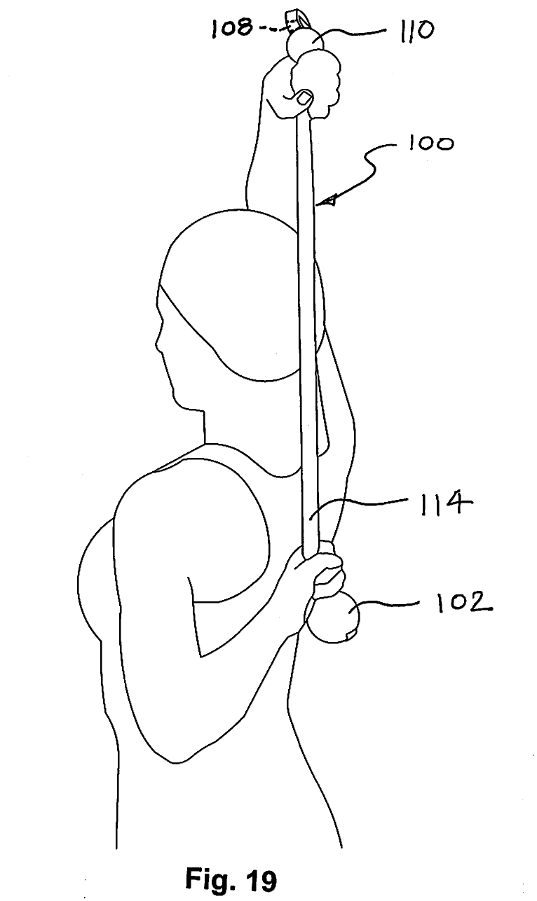

FIG. 19 shows an example of the massager 100 used for stretching. In this example the balls 110 and 102 are at opposite ends of the strap, which may help the user grasp and hold the massager 100 during stretching. As shown in FIGS. 14 and 19, a clamp or strap length adjuster 108 may be placed between an end of the strap 114 and either ball, to shorter the effective length of the strap as may be desired. If used, the adjuster 108 allows the user to select the spacing between the balls when the balls are at the ends of the strap 114. This allows the massager 100 to be adjusted for the users' height and arm length.

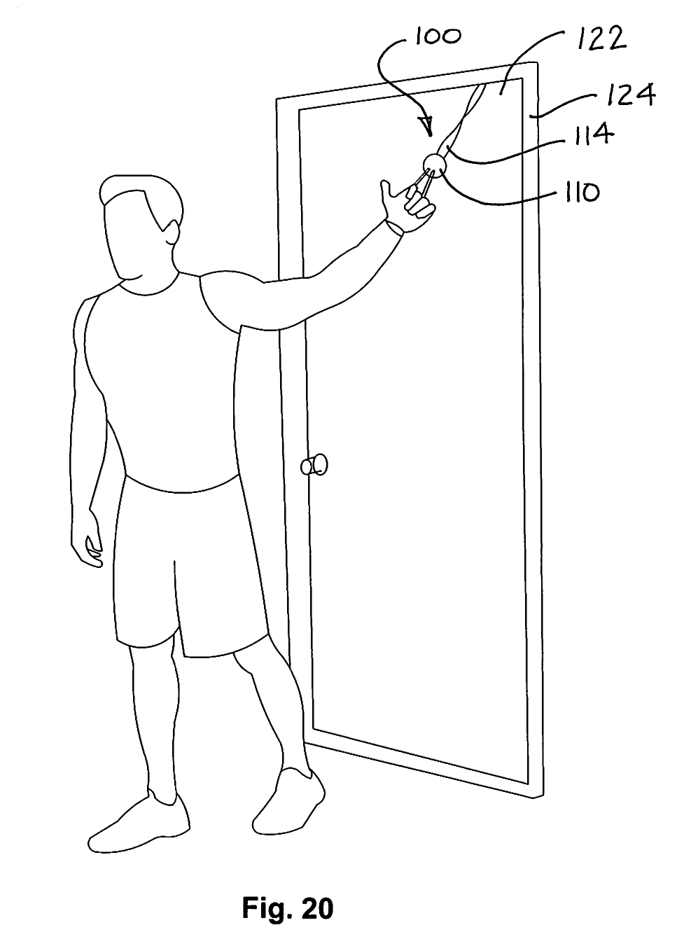

FIG. 20 shows another stretching exercise with either ball secured between a door 122 and a door frame 124. The user then grasps the other ball, or the looped end of the strap 114. By twisting the torso an arm and/or should stretch is performed. A second massager 100 may similarly be provided for the users other arm, to more effectively allow for strength exercises or for simultaneous left and right side stretching exercises.

Thus, novel massagers and methods have been shown and described. Various changes and substitutions may of course by made without departing from the spirit and scope of the invention. The invention, therefore, should not be limited, except by the following claims and their equivalents.

1. A massager comprising:
a holder having a cup opening;
an insert insertable into the cup opening, with the insert having a first end having a first curved shape, and a second end having a second curved shape different from the first curved shape.

2. The massager of claim 1 wherein the holder comprises a truncated sphere having a radius RR and with the first curved shape comprising a section of a sphere having a radius equal to RR plus or minus 10%.

3. The massager of claim 1 wherein the first curved shape comprises a section of a first sphere having a first radius and the second curved shape comprises a section of second sphere having a second radius, and wherein the first radius is at least two times the second radius.

4. The massager of claim 1 with the insert having a cylindrical body between the first end and the second end.

5. The massager of claim 1 with the holder comprising a material softer than the insert.

6. The massager of claim 1 with the insert and the cup opening dimensioned so that with the insert fully inserted into the holder, the holder and the insert form a substantially continuous sphere.

7. The massager of claim 1 with the cup opening including cylindrical sidewalls concentric with a central axis of the holder, and further comprising a plurality of ridges on the holder aligned parallel to the central axis.

8. The massager of claim 1 with a rim on the insert contacting a lip in the cup opening when the insert is fully inserted into the cup opening, and with a gap between a spherical cup surface at the bottom of the cup opening and the first end of the insert.

9. A massager comprising:
a holder having a cup opening; and
a ball assembly in the cup opening, with the ball assembly including a ball rotatably retained in a cup.

10. The massager of claim 9 wherein the holder comprises a truncated sphere of a material softer than the ball.

11. The massager of claim 10 with the cup having a cup plate closing off one end of a tubular body and a ball seat on an inner side of the cup plate.

12. The massager of claim 10 with the cup having an outer surface having a curvature substantially matching the curvature of the holder.

13. The massager of claim 11 further including a cap on an outer side of the cup plate.

14. The massager of claim 13 with the cap having a curvature substantially matching the curvature of the holder.

15. The massager of claim 9 with the ball assembly and the cup opening dimensioned so that with the ball assembly fully inserted into the holder, the holder and a cup bottom of the ball assembly form a substantially continuous sphere.

16. The massager of claim 9 with the cup opening including cylindrical sidewalls concentric with a central axis of the holder, and further comprising a plurality of ridges on the holder aligned parallel to the central axis.

17. A massager comprising:
a holder having a cup opening;
an insert insertable into the cup opening; and
first and second lengths of web extending through openings in the holder and in the insert, with both the holder and the insert slidable along lengths of web.

18. The massager of claim 17 with the holder comprising a truncated sphere and the insert comprising an inner ball.

19. The massager of claim 17 with the cup opening comprising a spherical recess.

20. The massager of claim 17 with the first and second lengths of web forming an endless loop.
